(19) United States
(12) Patent Application Publication
(10) Pub. No.: US 2024/0310074 A1
(43) Pub. Date: Sep. 19, 2024

(54) ROOM AIR MONITORING DEVICE

(71) Applicant: Rowan University, Glassboro, NJ (US)

(72) Inventors: Vincent Manna, Magnolia, NJ (US); Salvatore Caradonna, Voorhees, NJ (US)

(21) Appl. No.: 18/679,011

(22) Filed: May 30, 2024

Related U.S. Application Data
(63) Continuation of application No. PCT/US23/23458, filed on May 25, 2023.
(60) Provisional application No. 63/348,183, filed on Jun. 2, 2022.
(60) Provisional application No. 63/348,771, filed on Jun. 3, 2022.

(51) Int. Cl. F24F 13/20; F24F 1/0011; F24F 1/0022; F24F 110/10

(52) U.S. Cl. CPC F24F 13/20; F24F 1/0011; F24F 1/0022; F24F 2110/10

(57) ABSTRACT

A room air monitoring device for exposing human airway model system/tissue or other media to ambient air for air quality monitoring purposes. The device includes a housing defining an exposure chamber, and a chamber cap defining an opening for admitting air into the exposure chamber. The device also includes an intake fan operable to draw ambient air through the chamber cap, into the exposure chamber, and out of the exposure chamber. A temperature maintaining system can heat an interior of the exposure chamber to a temperature approximating a human body tissue temperature. A control system maintains a temperature of the exposure chamber within a desired temperature range, and may selectively energize the electric motor to draw ambient air into the exposure chamber. The testing device components may be constructed of a biocompatible material that is autoclavable without detrimental degradation.

### CROSS-REFERENCE TO RELATED APPLICATIONS

This application is a continuation of International Application No. PCT/US2023/023458, filed Dec. 7, 2023, which claims the benefit of priority, under 35 U.S.C. § 119(e), of U.S. provisional patent application Nos. 63/348,183, filed Jun. 2, 2022, and 63/348,771, filed Jun. 3, 2022, the entire disclosure of each of which is hereby incorporated herein by reference.

### FIELD OF THE INVENTION

The present invention relates generally to room air monitoring devices, and more particularly to a room air monitoring device for monitoring, sample gathering and/or testing of ambient/room air for ambient airborne materials.

### DISCUSSION OF RELATED ART

There is a need for monitoring of the quality or ambient air in various applications. Of particular interest, is monitoring room air for airborne materials, such as particles or particulate matter, chemicals, pathogens, etc., that may be deleterious to human health. This would be of utility in hospital settings that are especially concerned with rapidly identifying the presence of communicable diseases such as in intensive care units, neonatal intensive care units, infant nursery wards, surgical centers, chemotherapy centers, and organ transplant facilities.

What is needed is a testing device designed to be paired with human model airway tissues for sample gathering and/or testing of the room air so that the safety, risks, and ramifications of present airborne materials can be assessed. Further, what is a needed is such a device that is sufficiently lightweight and compact to be readily usable and unobtrusive in most indoor spaces and/or within air handlers or HVAC ducting.

### SUMMARY

The present invention relates generally to a room air monitoring device for monitoring, sample gathering and/or testing of ambient/room air for ambient airborne materials, particularly those that may be detrimental to human health. The device is specially-configured to be a compact device that is readily usable and unobtrusive in most indoor spaces. Additionally, the device is configured to receive and contain a medium and/or sample for exposure to the ambient air, such as human airway model tissue, for example air-liquid interface (“ALI”) tissue, within an internal exposure chamber while a radial fan creates a flow of ambient air through the chamber. The device can take advantage of the characteristics of ALI tissue to facilitate the detection of ambient airborne pathogens.

The room air monitoring device is effectively a fan-driven air pump that contains a small piece of living airway tissue in its core. The device is meant to continually sample ambient air and pass it over the surface of the tissue culture, which acts as a target for airborne respiratory pathogens to infect for later detection. The tissue is then washed or collected and replaced at regular intervals for rapid analysis and identification of airborne pathogens using commercial rapid diagnostic tests or ELISA assays, which can be performed on location or in a remote laboratory.

The room air monitoring device has utility in a variety of settings and applications, including for example, hospital settings that are especially concerned with rapid identification of the presence of communicable diseases, such as in intensive care units, neonatal intensive care units, infant nursery wards, surgical centers, chemotherapy centers, and organ transplant facilities. The room air monitoring device can also be paired with other tissue models or cell-lines for research investigations in the airborne transmission/deposition of particles, chemicals, pathogens, and other airborne materials.

### BRIEF DESCRIPTION OF THE FIGURES

An understanding of the following description will be facilitated by reference to the attached drawings, in which:

FIG. 1 is a side view of an exemplary room air monitoring device in accordance with an exemplary embodiment of the present invention; and

FIG. 2 is an exploded side view of the room air monitoring device of FIG. 1.

### DETAILED DESCRIPTION

The present invention provides a room air monitoring device for monitoring, sample gathering and/or testing for the room air for ambient airborne materials, such as pathogenic viruses, bacteria, and yeast, etc. The device is specially-configured to be a compact device that is readily usable and unobtrusive in most indoor spaces.

The room air monitoring device includes an internal exposure chamber for containing a tissue sample or other media while a radial fan creates a flow of ambient air through the chamber. In certain embodiments, the device is configured to contain air-liquid interface (ALI) or other human model airway tissue within the exposure chamber. The ALI model system has existed for over 20 years and is used in various lines of research to generate functioning airway mucociliary tissue in-vitro from adult stem cells. ALI tissue cultures contain the same cellular populations, tissue structure, and function as human respiratory mucociliary tissue and can be maintained for months at a time, making ALI tissues an ideal model of primary airway tissue. ALI tissue cultures and humans are both susceptible to the same respiratory pathogens, for example, influenza viruses, rhinoviruses, coronaviruses, or Pseudomonas bacteria. ALI tissue can be maintained for months in culture, allowing for investigations in airway tissue responses after exposure to experimental compounds of interest.

The device may include a temperature maintaining system, e.g., including a heating element such as a flexible polyimide film heater, temperature monitoring device and a control system, to keep the tissue sample at approximately 98 degrees Fahrenheit (e.g., a healthy human body temperature) despite room air temperatures, to approximate body tissue temperatures for the tissue within the device. The device takes advantage of the characteristics of tissue to facilitate the detection of ambient airborne pathogens.

In an exemplary embodiment, the housing and fans of the device are 3-D printed from a biocompatible photopolymer resin, e.g., using a FormLabs3b dental 3D-printer. In ap referred embodiment, the housing is formed of transparent material, such as Dental LT Clear (V2).

In a certain embodiment, the fan is driven by a 6-volt miniature electric motor that is controlled by an Arduino nano microcontroller. In certain embodiments, the device may be powered via a standard 120-volt power outlet.

In an exemplary embodiment, the fan is a radial fan, and thus the device employs a radial fan-driven air blower to create the air flow into an exposure chamber, which allows for a particularly compact and lightweight device. The device may be small, e.g., measuring approximately 3 inches in diameter and approximately 6 inches in height, which makes it readily usable and unobtrusive in most indoor spaces, within an air handler or HVAC duct, etc. Further, the components for the device may be 3D printed, which makes production less demanding. Further still, in a preferred embodiment, the device is made from durable biocompatible materials that are autoclavable, which allows for simple and effective sterilization.

Combining the device with the ALI model system provides a practical solution and alternative to animal models for an investigator studying the effects that airborne materials have on respiratory tissues. For the investigators already utilizing ALI tissue, the device is an affordable alternative to large, bulky and expensive research equipment. The device is a compact and affordable device suitable for use in the field/commercial/industrial/living environments that is designed specifically to be paired with the ALI tissue model system. Advantageously, the device is much more compact, and the exposure chamber and air flow generator are combined into a single integrated unit for simplicity and ease of transport.

The room air monitoring device 100 is a compact, all-in-one system for delivering a flow of room air to the surface of cultured air-liquid interface tissues, other cultured cells, or suitable media. This is accomplished by a fan-driven air-intake that draws ambient room air through the device, through an exposure chamber that houses the tissue sample or other media.

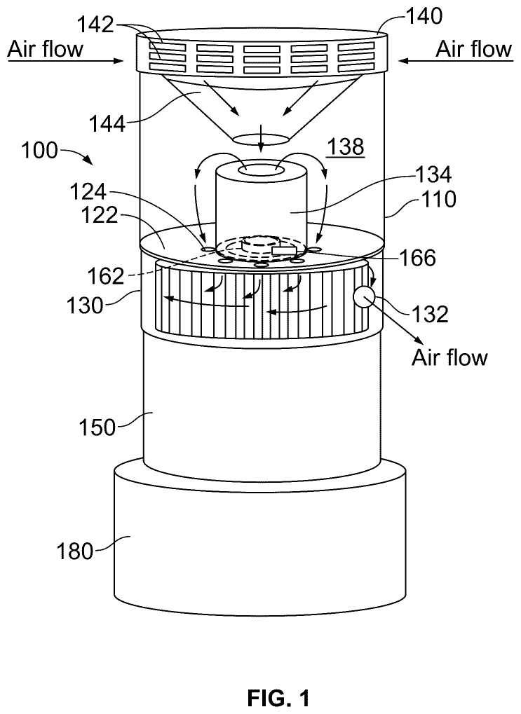

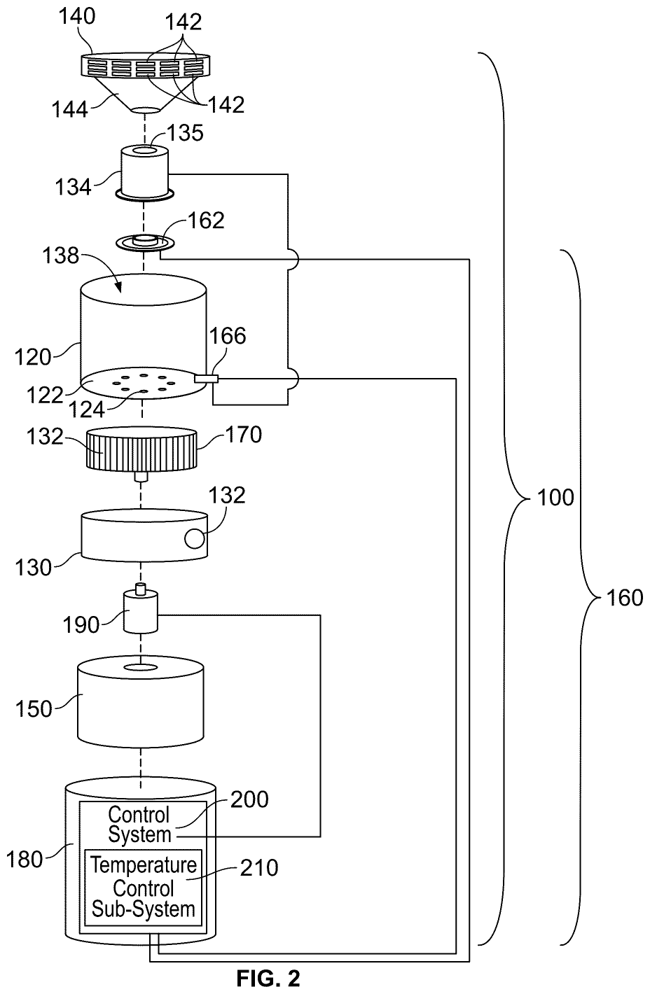

Referring now to FIGS. 1 and 2, the exemplary testing device 100 has a compact, upright form factor and comprises a housing 110 including an exposure chamber housing 120 that is matable with a chamber cap 140 and a fan housing 130. The exposure chamber housing 120 has a floor 122 defining openings 124 for air to pass through the exposure chamber housing 120, into the fan housing 130, and to exhaust from the fan housing 130 and device 100 via an exhaust port 132. Together with the chamber cap 140 and the fan housing 130, the exposure chamber housing 120 defines an internal exposure chamber 138 dimensioned to receive a container 134 configured to hold ALI or other tissue culture, or other media/material. In use, for example, ALI tissue may be placed into the container 134, and the container may be placed into the internal exposure chamber 138, as will be appreciated from FIG. 1.

The chamber cap 140 covers the top of the exposure chamber housing 120 to keep out coarse debris, etc. The chamber cap 140 defines openings 142 such that it admits passage of ambient air into the exposure chamber housing 120 and exposure chamber 138. In this exemplary embodiment, the chamber cap 140 further includes a frustoconical side wall 144 extending downwardly from an upper portion of the chamber 140. The side wall 144 acts like a funnel to direct ambient air into an opening 135 in the container 134.

A temperature modification device 162, such as a flexible polyimide resistive film heater, of a temperature maintaining system 160, is positioned in the exposure chamber 138, e.g., adhered to the floor 122 of exposure chamber housing 120, preferably in a position to abut a surface of a tissue culture container 134 positioned in the exposure chamber 138. The temperature maintaining system 160 further includes a temperature monitoring device 166 (such as a thermistor or thermocouple and a temperature control sub-system 210 (which may be incorporated into control system 200 of the device, such as an Arduino microcontroller, as discussed below), to keep the ALI tissue sample, etc. at approximately 98 degrees Fahrenheit despite room air temperatures, to approximate body tissue temperatures for the ALI tissue within the device.

The fan housing 130 is dimensioned to house an intake fan 170, such as a radial fan. The intake fan 170 is driven to provide a flow of ambient air the exposure chamber, e.g., through the openings 142 of the chamber cap 140, and exiting the device via at least one opening in the bottom of the exposure chamber that leads into the fan housing which has at least one opening 124 that acts as the final exit point and outlet port of ambient air from the device. A radial fan configuration is particularly compact and thus desirable in the current configuration, although alternative fan configurations may be used.

The fan housing 130 is configured to sit atop and/or otherwise mate with a fan motor housing 150. The fan motor housing 150 is dimensioned to house and support an electric motor 190 that is mechanically interconnected with the fan 170 to drive rotational motion thereof when the electric motor 190 is energized. The electric motor may be a 6-volt miniature electric motor. The electric motor 190 is further operatively coupled to a control system 200 configured for driving the fan. The control system 200 is also operatively coupled to the temperature monitoring device (not shown) and the temperature modification device 162, and is configured with logic operative to cause the control system 200 to selectively energize the temperature modification device 162 or otherwise control it to maintain the exposure chamber, container and/or tissue/sample therein at a desired temperature or within a desired temperature range, such as 98 degrees Fahrenheit.

The fan motor housing 150 is configured to sit atop and/or otherwise mate with a control system housing 180. The control system housing 180 is dimensioned to house and support the control system 200, which may include an Arduino nano or other microcontroller suitably configured for driving the fan and operating the temperature control system 160, a power supply, etc.

During operation, the control system 200 energizes the fan motor 190 and causes it to run, e.g., continuously or for extended cycles. This causes the fan to draw ambient air through the chamber cap 140, into the exposure chamber 138 and into contact with an ALI tissue sample or other material in the container 134, and then to exit the device via at least one opening in the bottom of the exposure chamber that leads into the fan housing which has at least one opening that acts as the final exit point of ambient air (not shown). This exposes the tissues or other sample in the container 134 to the ambient air, and therefore, to any airborne materials entrained in the ambient air.

Further the control system 200 selectively energizes or otherwise controls the temperature control system, e.g., to energize resistive heating film until the exposure chamber, container and/or sample reaches a desired temperature, and then to de-energize the heating file, monitor the temperature and then selectively re-energize and de-energize the heating film to maintain a current temperature in a desired temperature range. For example, this allows an ALI tissue sample to be maintained at a temperature approximating a human body temperature, despite a lower ambient temperature, so that a more realistic/accurate tissue culture may be performed.

After a period of time, a person may remove the chamber cap 140, remove the container 134 from the device, remove the tissue sample, etc. from the container if desired, and place a container with new tissue back into the device for continued operation. For example, it may be desirable to change tissue samples approximately every 5-7 days. By way of example, rapid antigen testing for a variety of respiratory pathogens may be performed using saline samples collected after washing the tissue sample surface, tissue samples can also be collected and processed in a suitable laboratory environment for detection of pathogens via western blotting with disease-specific antibodies, RNA may also be isolated from tissue samples for identification of the genetic material of pathogens by using quantitative polymerase chain reaction technique.

In certain embodiments, the tissue samples will need to be changed at regular intervals to avoid complete exhaustion of culture media. When transparent material is used to construct the exposure chamber housing and the culture media container, this allows the user to monitor the appearance of the tissue surface and clarity of culture media for excessive contamination before scheduled tissue changes.

In certain embodiments, the container, exposure chamber housing, camber cap, etc. may be modified to accommodate multiple different tissue cultures or samples simultaneously.

Accordingly, the device effectively uses human airway ALI or other tissue cultures or culture/filter media as a ‘biological filter’ for trapping respiratory pathogens, in contrast to other devices that use proprietary mechanical filters to capture ambient air samples for downstream detection of pathogens. The device thereby can act as an airborne pathogen detection system, capable of capturing viruses and bacteria on a biological living filter which allows for their detection using clinical rapid diagnostic tests. The purpose is to capture and identify airborne pathogens when they have been present in an indoor setting.

In contrast, many prior art devices use proprietary consumable tests to analyze the collected samples, the present invention uses ALI tissue culture (or other tissue) biological filters that allow samples to be analyzed on location using clinical rapid diagnostic tests. This lowers costs for the users by allowing them to buy tests only for the pathogens they are interested in detecting. Further, the device is simple to produce because of the use of 3D printing and common electronic components. Therefore, this device could be much more affordable for the consumer compared to the limited alternatives.

The device of the present invention is more compact than other devices, which allows it to fit inside of hard-to-reach spaces such as air-handlers. It's a simple device that primarily uses a fan and a heating pad, and thus is much less likely to face operator error or technology failure.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A room air monitoring device comprising:
a housing defining a substantially-closed exposure chamber, said housing comprising an exposure chamber housing matable with a chamber cap, said chamber cap defining an opening for admitting passage of ambient air into the exposure chamber;
an intake fan assembly comprising a fan housing, an intake fan and an intake fan electric motor operatively connected to the intake fan to drive rotation of the intake fan when the intake fan electric motor is energized, and to draw ambient air through the chamber cap, into the exposure chamber, and to drive air from the exposure chamber;
a temperature maintaining system comprising a temperature modification device configured to heat an interior of the exposure chamber above ambient temperature; and
a control system operable to selectively operate said temperature control device to maintain a temperature of said exposure chamber within a desired temperature range, and to energize said intake fan electric motor to cause said intake fan to draw ambient air into said exposure chamber.

2. The room air monitoring device of claim 1, wherein said intake fan comprises a radial fan.

3. The room air monitoring device of claim 1, wherein said housing and said intake fan and are constructed of a biocompatible material that is autoclavable without detrimental material degradation.

4. The room air monitoring device of claim 3, wherein said biocompatible material is a photopolymer resin.

5. The room air monitoring device of claim 3, wherein said housing, said intake fan is constructed using an additive manufacturing process.

6. The room air monitoring device of claim 1, wherein at least one of said housing and said fan housing defines an outlet port configured to exhaust air in the exposure chamber from the device.

7. The room air monitoring device of claim 1, further comprising a container configured to hold at least one of a tissue culture and other media;
wherein said exposure chamber is dimensioned to receive said container.

8. The room air monitoring device of claim 7, wherein said chamber cap comprises a side wall extending downwardly from an upper portion of the chamber to funnel ambient entering said chamber cap into said container.

9. The room air monitoring device of claim 1, wherein said temperature modification device comprises a resistive film heater disposed in a position that is at least one of in the exposure chamber and adjacent the exposure chamber.

10. The room air monitoring device of claim 1, wherein said temperature maintaining system comprises:
a temperature monitoring device configured to determine a temperature within the exposure chamber; and
a temperature control system configured to selectively energize said heater to maintain the temperature within the exposure chamber within a desired temperature range.

11. The room air monitoring device of claim 1, a temperature monitoring device configured to determine a temperature within the exposure chamber; and
a temperature control system configured to selectively energize said heater to maintain the temperature within the exposure chamber within a desired temperature range that approximates a body tissue temperature of a living being.

12. The room air monitoring device of claim 10, wherein said temperature monitoring device comprises at least one of a thermistor and a thermocouple.

13. The room air monitoring device of claim 10, wherein said temperature control system is configured as a sub-system of said control system.

14. The room air monitoring device of claim 1, wherein said fan housing defines at least one opening providing an outlet port for exhausting air from the exposure chamber.

15. The room air monitoring device of claim 1, wherein said fan assembly further comprises a fan motor housing configured to mate with and support said fan housing, and to house said electric motor.

16. The room air monitoring device of claim 1, wherein said housing further defines a control system compartment dimensioned to receive and house said control system.

17. The room air monitoring device of claim 1, wherein said control system comprises a microcontroller.

18. A method for monitoring the quality of ambient air, the method comprising:
providing a room air monitoring device for exposing ambient air to a medium, the device comprising:
a housing defining a substantially-closed exposure chamber, said housing comprising an exposure chamber housing matable with a chamber cap, said chamber cap defining an opening for admitting passage of ambient air into the exposure chamber;
an intake fan assembly comprising a fan housing, an intake fan and an intake fan electric motor operatively connected to the intake fan to drive rotation of the intake fan when the intake fan electric motor is energized, and to draw ambient air through the chamber cap, into the exposure chamber, and to drive air from the exposure chamber;
a temperature maintaining system comprising a temperature modification device configured to heat an interior of the exposure chamber above ambient temperature; and
a control system operable to selectively operate said temperature control device to maintain a temperature of said exposure chamber within a desired temperature range, and to energize said intake fan electric motor to cause said intake fan to draw ambient air into said exposure chamber;
disposing the medium in a container;
placing the medium-containing container in the exposure chamber of the room air monitoring device; and
operating said room air monitoring device to pass ambient air through the exposure chamber of said device, to expose the medium to said ambient air.

19. The method of claim 18, further comprising:
retrieving the medium from said room air monitoring device; and
analyzing the medium exposed to said ambient air to assess a quality of said ambient air.

20. The method of claim 18, wherein said disposing the medium in said container comprises disposing air-liquid interface human airway model in the container.

21. The method of claim 18, further comprising:
operating said room air monitoring device to maintain a temperature within the exposure chamber within a desired temperature range that approximates a body tissue temperature of a living being.
